(19) United States
(12) Patent Application Publication
(10) Pub. No.: US 2007/0115828 A1
(43) Pub. Date: May 24, 2007

(54) Method for sending requests in a network

(76) Inventors: Ramandeep Ahuja, Chicago, IL (US); Randy L. Ekl, Lake Zurich, IL (US)

Correspondence Address: MOTOROLA, INC., 1303 EAST ALGONQUIN ROAD, IL01/3RD, SCHAUMBURG, IL, 60196, US

(21) Appl. No.: 11/283,271

(22) Filed: Nov. 18, 2005

(51) Int. Cl. H04L 12/26; H04L 12/56

(52) U.S. Cl. 370/236; 370/400

(57) ABSTRACT

A method for sending requests in a network (100) is disclosed. The network includes a plurality of nodes and a plurality of wireless base stations. Each of the plurality of nodes is associated with at least one wireless base station in the network. The method includes receiving at a wireless base station a request for at least one destination node from a source node. A batch route request is generated based on the request. The batch route request is sent to the network for delivery to the at least one destination node.

### FIELD OF THE INVENTION

The present invention generally relates to the field of networks, and more specifically to a method for sending requests in a network.

### BACKGROUND OF THE INVENTION

With an increase in the need for communication and information exchange, wireless networks are becoming increasingly popular. Wireless networks may be infrastructure-based or infrastructure-less networks. Infrastructure-based wireless networks include fixed wireless base stations that are distributed geographically at designated locations throughout an area. The wireless base stations provide coverage to nodes such as mobile phones, computers, laptops, Personal Digital Assistants (PDAs), mobile computational devices, and the like. In infrastructure-less wireless networks, such as ad hoc networks, each node is capable of operating as a wireless base station or a router for the other nodes in the network. Further, a node is capable of taking part in the discovery and maintenance of routes for other nodes in the network.

The nodes in the wireless network send requests to other nodes in the network. For example, a source node may send a request for determining a route to a destination node in the network. Wireless networks use various protocols, including an Ad hoc On-demand Distant Vector Routing (AODV), a Dynamic Source Routing Protocol (DSRP), and so forth, for sending such requests. These routing protocols determine the routes from the source node to the destination node.

The node may at times broadcast requests to the network. For example, for determining a route to a destination node, a node may send a request for route discovery. This process may involve broadcasting a route request until the route is determined. However, broadcasting a request for each node associated with the wireless base station results in a high bandwidth overhead for the network. Further, sending requests for each route, separately, results in a delay in determining routes. Accordingly, there exists a need for a new method for sending requests in a network.

### BRIEF DESCRIPTION OF THE FIGURES

The present invention is illustrated by way of example, and not limitation, in the accompanying figures, in which like references indicate similar elements, and in which:

FIG. 1 is a block diagram illustrating an exemplary network, in accordance with an embodiment of the present invention.

FIG. 2 is a block diagram illustrating an exemplary hierarchical network, in accordance with another embodiment of the present invention.

FIG. 3 is a flowchart illustrating the steps involved in sending requests in a network, in accordance with an embodiment of the present invention.

FIG. 4 is a flowchart illustrating the steps involved in determining routes in a network, in accordance with an embodiment of the present invention.

FIG. 5 is a block diagram illustrating a header of a batch route request, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Various embodiments of the present invention provide a method for sending requests in a network. The network includes a plurality of nodes and a plurality of wireless base stations. Each of the plurality of nodes is associated with at least one wireless base station in the network. A wireless base station receives at least one request for at least one destination node from at least one associated node. A batch route request is generated, based on this request, and sent to the network for delivery to the at least one destination node.

Before describing in detail the particular method for sending requests in a network in accordance with the present invention, it should be observed that the present invention resides primarily in combinations of method steps related to the method for sending requests in the network. Accordingly, the method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second and the like may be used solely to distinguish one entity or action from another entity or action without necessarily requiring or implying any actual such relationship or order between such entities or actions. The terms ‘comprises,’ ‘comprising,’ or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by ‘comprises . . . a’ does not, without more constraints, preclude the existence of additional identical elements in the process, method, article, or apparatus that comprises the element.

The term ‘another’, as used herein, is defined as at least a second or more. The terms ‘including’ and/or ‘having’, as used herein, are defined as comprising.

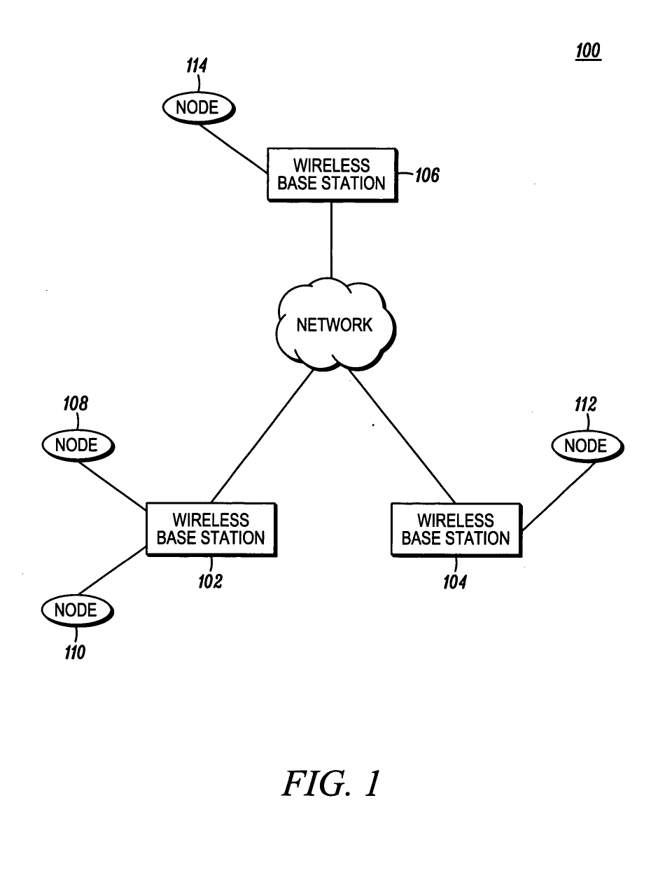

FIG. 1 is a block diagram illustrating an exemplary network 100, in accordance with an embodiment of the present invention. The network 100 may be geographically spread over an area, such as an office building, a campus, a city, and so forth. Examples of the network 100 include a Local Area Network (LAN), a Metropolitan Area Network (MAN), a Wide Area Network (WAN) such as Internet, and the like. The network 100 may be a centralized network, a peer-to-peer network, and the like. The network 100 includes a number of wireless base stations. For the purpose of this description, the network 100 is shown to include a wireless base station 102, a wireless base station 104, and a wireless base station 106. These wireless base stations may be interconnected through wired means or wireless means in the form of a hierarchy topology, a ring topology, a bus topology, a star topology, a tree topology, a mesh topology, or any other existing topology. In an embodiment of the present invention, the wireless base stations in the network 100 may be fixed. In another embodiment of the present invention, the wireless base stations may be mobile. The mobile wireless base stations in the network 100 are free to move randomly and organize themselves in the network 100.

The network 100 further includes a number of nodes. Examples of the nodes include, but are not limited to, mobile phones, computers, laptops, Personal Digital Assistants (PDAs), mobile computational devices, and the like. For the purpose of this description, the network 100 is shown to include a node 108, a node 110, a node 112, and a node 114. Each node in the network 100 is associated with at least one wireless base station. The nodes associated with a wireless base station are under a coverage area of the wireless base station. For example, the node 108 and the node 110 are associated with the wireless base station 102. Similarly, the node 112 is associated with the wireless base station 104, and the node 114 is associated with the wireless base station 106. These nodes communicate through wired means or wireless means and may either be fixed nodes or mobile nodes.

As is known to one of ordinary skill in the art, terms such as source, destination, receiver, transmitter, and next hop are used to describe communication in the network 100. For example, if node 108 were to send a data packet to node 112, node 108 is considered to be a source node and node 112 is considered to be a destination node. Further, since node 108 is associated with wireless base station 102 and wireless base station 102 is used to send the data packets from node 108 to node 112, wireless base station 102 is considered to be a transmitter. Also, if wireless base station 104 is directly connected to wireless base station 102, then wireless base station 104 is considered to be a receiver and is called a “next hop” for wireless base station 102.

To enable efficient communications in the network 100, the wireless base stations 102, 104, 106 maintain routing tables with network topology. For the example of node 108 sending a data packet to node 112, wireless base station 102 maintains a routing table with entries for source node 108, receiver 104, and destination node 112 (in addition to other nodes and wireless base stations that wireless base station 102 becomes aware of).

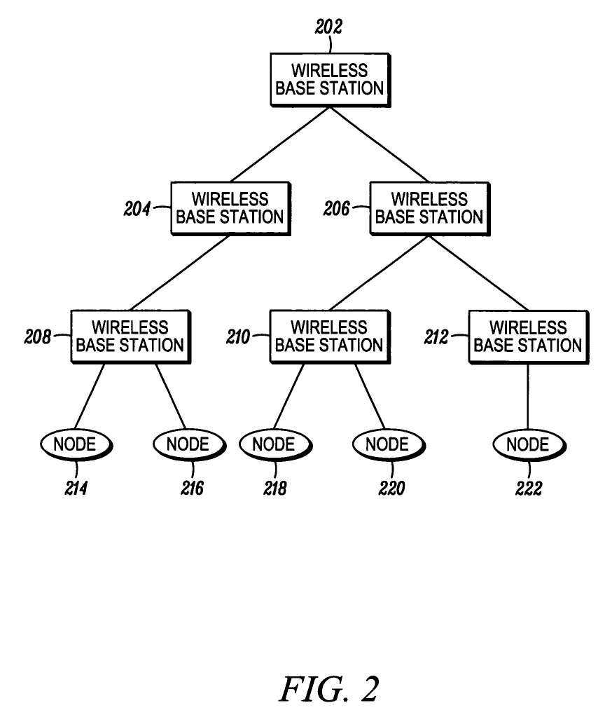

FIG. 2 is a block diagram illustrating an exemplary hierarchical network 200, in accordance with another embodiment of the present invention. The hierarchical network 200 includes a number of wireless base stations that are interconnected in the form of a hierarchy topology. The hierarchical network 200 is shown to include a wireless base station 202, a wireless base station 204, a wireless base station 206, a wireless base station 208, a wireless base station 210, and a wireless base station 212. In the hierarchical network 200, the wireless base station 208 is associated with the wireless base station 204. Similarly, the wireless base station 210 and the wireless base station 212 are associated with the wireless base station 206, and the wireless base station 204 and the wireless base station 206 are associated with the wireless base station 202. The hierarchical network 200 further includes a number of nodes. For the purpose of this description, the hierarchical network 200 is shown to include a node 214, a node 216, a node 218, a node 220, and a node 222. Each node in the hierarchical network 200 is associated with at least one wireless base station. For example, the node 214 and the node 216 are associated with the wireless base station 208. Similarly, the node 218 and the node 220 are associated with the wireless base station 210, and the node 222 is associated with the wireless base station 212. In the hierarchical network 200, each of the wireless base stations and nodes are also associated with other wireless base stations above it. For example, the node 214 is associated with the wireless base station 204 and the wireless base station 202, in addition to the wireless base station 208.

In the hierarchical network 200, the wireless base stations may be interconnected through wired means or wirelessly. In an embodiment of the present invention, the wireless base stations may be fixed. In another embodiment of the present invention, the wireless base stations may be mobile. Each of the mobile wireless base stations in the hierarchical network 200 is free to move randomly and organize itself in the hierarchical network 200.

Specifically, in FIG. 2, wireless base station 208 may have knowledge of wireless base station 210 because wireless base station 210 may be within wireless coverage of wireless base station 208 and as such both wireless base stations 208, 210 are included in each other's routing tables. Identifying adjacent wireless base stations (e.g. 208, 210) is traditionally not known in prior art hierarchical networks. Knowing adjacent wireless base stations assists with secondary route determination so that data packets are more efficiently transmitted in the hierarchical network. Specifically, a data packet from source node 214 to destination node 218 may traverse a route more directly via wireless base stations 208, 210 than having to traverse a route via wireless base station 202.

In various embodiments of the present invention, the wireless base stations may be one of a Coverage Access Point (CAP), an Infrastructure Backhaul Unit (IBU), and a Master Backhaul Unit (MBU) as those terms are known in the art. For example, in the hierarchical network 200, the wireless base station 208, the wireless base station 210 and the wireless base station 212 may be Coverage Access Points (CAP), the wireless base station 204 and the wireless base station 206 may be Infrastructure Backhaul Units (IBU), and the wireless base station 202 may be a Master Backhaul Unit (MBU). The MBU may be connected to a wired infrastructure to provide a communication link to nodes in any other network that are connected to the hierarchical network 200.

In an embodiment of the present invention, the hierarchical network 200 may be a wireless ad hoc network. Each node in the wireless ad hoc network has wireless communications and networking capability. The networking capability enables each node to operate as a wireless base station or as a router for the other nodes in the wireless ad hoc network. The nodes in the wireless ad hoc network may communicate with each other without any centralized administrator. Each node in the wireless ad hoc network is capable of functioning as a router where a router is as is known to one of ordinary skill in the art. The network topology in the wireless ad hoc network is in general dynamic, because connectivity among the nodes may vary with time due to node mobility, node departures and new node arrivals. Wireless ad hoc networks use routing protocols such as the Ad hoc On-demand Distant Vector Routing Protocol (AODV), the Cluster Based Routing Protocol (CBRP), the Dynamic Source Routing Protocol (DSRP), and so forth, to enable the nodes to communicate. Further, the protocol may be based on table driven routing protocols such as Dynamic Distance Sequenced Distance Vector Routing Protocol (DSDV), Wireless Routing Protocol (WRP), and the like.

As mentioned above, each node in the exemplary network is capable of functioning as a router. Further, each wireless base station functions as a router. As is known to one of ordinary skill in the art, a router forwards data packets to a next hop. Thus, in the networks of FIGS. 1 and 2, each node and wireless base station is capable of forwarding data packets to a next hop. Moreover, such forwarding may be performed at either a layer two or layer three of a network protocol stack (e.g. Open Systems Interconnection data link or network layers). For example, where the node or wireless base station functions as a layer two router, the node or wireless base station receives a data packet, determines a destination by retrieving a media access control (MAC) address from the data packet, and sends the data packet in a direction of a destination having the MAC address. Similarly, where the node or wireless base station functions as a layer three router, the node or wireless base station receives a data packet, determines a destination by retrieving an IP address from the data packet, and sends the data packet in a direction of a destination having the IP address. In any case, an embodiment of the present invention is contemplated to function at either layer two or layer three.

As is known in the art, a typical function of a router is to forward data packets based upon a destination address to a next hop if the route is known. As previously mentioned, the router maintains a routing table with destination addresses for a next hop, e.g. wireless base station or node.

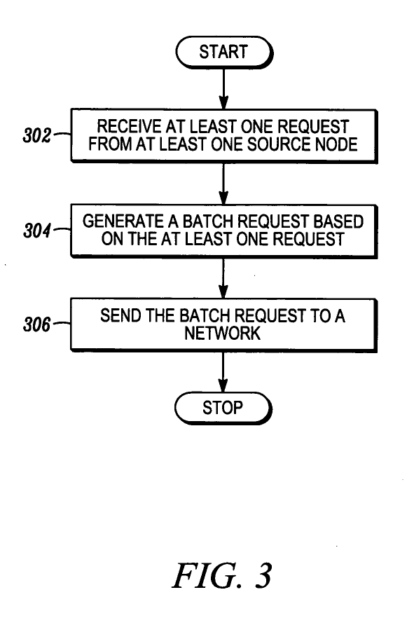

FIG. 3 is a flowchart illustrating the steps involved in sending requests in a network (e.g. the network of FIG. 1 or FIG. 2), in accordance with an embodiment of the present invention. At step 302, one or more requests are received at a wireless base station. In an embodiment of the present invention, these one or more requests may be requests for determining a route from a source node to a destination node and as such, a request identifies the destination node by a destination address. As mentioned earlier, if the wireless base station functions as a layer two router, then the destination address is identified by a MAC address and if the wireless base station functions as a layer three router, then the destination address is identified as an IP address. Further, in one embodiment, the requests adhere to a wireless ad-hoc routing protocol, such as the Ad hoc On-demand Distant Vector Routing (AODV) protocol and others as previously mentioned.

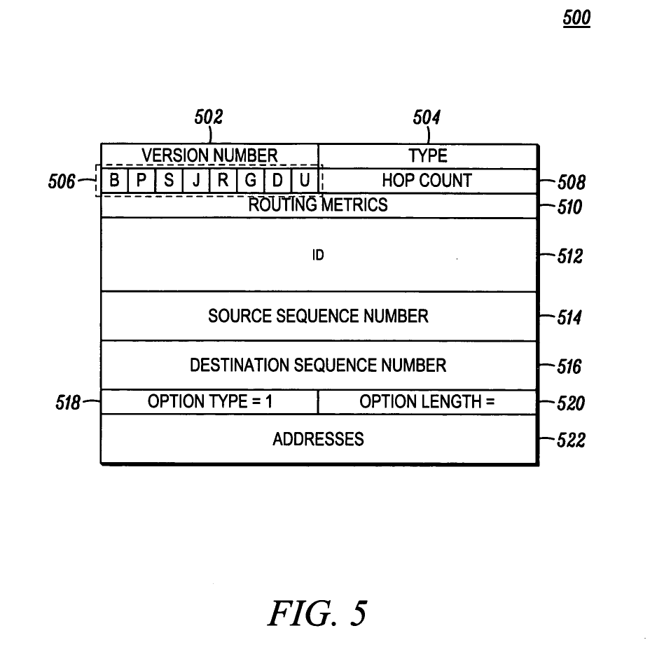

At step 304, the wireless base station generates a batch route request on receiving the one or more requests. Generating the batch route request includes identifying the requests that are to be batched together based on predefined parameters. The predefined parameters include a time duration of association of the one or more source nodes with the corresponding wireless base station. For example, a node associated with a wireless base station for a longer duration may get preference. The predefined parameters also include a priority of the one or more source node; a priority of data (e.g., voice or video) type, for example, video data may get preference over voice data; a number of requests; and a time interval between the batch route requests sent by the wireless base station to the network. On identifying the requests, the wireless base station generates the batch route request. In an embodiment of the present invention, generating the batch route request includes determining the addresses of at least one destination node and listing the addresses in a field in the batch route request. The determined addresses and the address of the wireless base station are utilized to construct the batch route request (e.g. as shown in FIG. 5). In another embodiment of the present invention, generating the batch route request includes entering sequence numbers of the at least one destination node in the batch route request.

At step 306, the wireless base station sends the batch route request to the network. In accordance with an embodiment of the present invention, the wireless base station broadcasts the batch route request to the network. The broadcast may be a multihop broadcast where multihop broadcast is known to one of ordinary skill in the art as broadcasting via multiple nodes (or wireless base stations) where each node (or wireless base station) forwards broadcast packets to other nodes (wireless base stations). As is known in the art, a multihop broadcast is performed by setting the destination address to a broadcast address, e.g. 0xFFFF. In addition, broadcast may require that the wireless base station sends more than one transmission to neighboring nodes (or wireless base stations) as identified in a routing table of the wireless base station.

In an embodiment of the present invention, when at least one wireless base station receives a batch route request, the wireless base station sends a reply in response to the received batch route request. For example, in network 100, the wireless base station 102 may receive requests from nodes 108 and 110. On receiving the requests, the wireless base station 102 generates a batch route request based on the requests. On generating the batch route request, the wireless base station 102 sends the batch route request to the network 100. In an embodiment of the present invention, the wireless base station 102 broadcasts the batch route request to the network 100.

Similarly, in hierarchical network 200, the wireless base station 208 may receive requests from nodes 214 and 218. On receiving the requests, the wireless base station 208 generates a batch route request based on the requests. In another embodiment of the present invention, the batch route request may be generated by any of the wireless base stations providing coverage to the node 214. The batch route request may also be generated by any one of the wireless base station 208, the wireless base station 204, and the wireless base station 202. On generating the batch route request, the wireless base station 208 sends the batch route request to the hierarchical network 200.

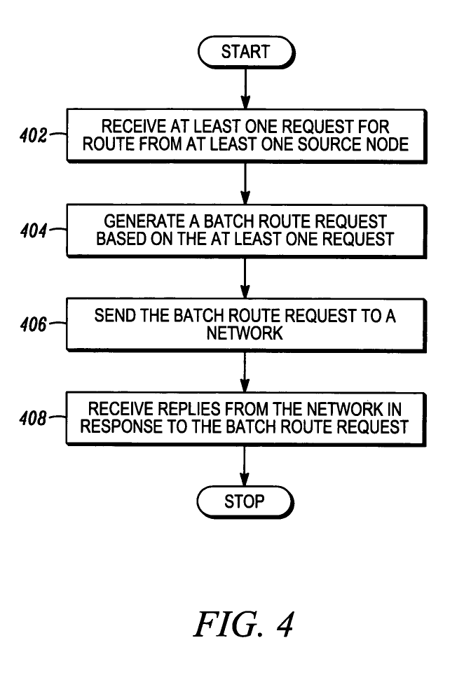

FIG. 4 is a flowchart illustrating the steps involved in determining routes in a network, in accordance with an embodiment of the present invention. At step 402, at least one request for determining a route to at least one destination node from one or more source node is received at a wireless base station. The route may be a primary or a secondary route. The primary route is directed towards the wireless base station providing coverage to the node. The primary route may be predetermined and is generally an optimal route from the source node to the destination node. The primary route may be determined based on various criteria such as bandwidth constraints, a path length, and the like. For example, a primary route between nodes 214 and 218 is via wireless base stations 208, 204, 202, 206, and 210.

The secondary route is an additional route from the source node to the destination node, in addition to the primary route. For example, a secondary route between nodes 214 and 218 is established by wireless base station 208 forwarding the data packet directly to wireless base station 210, instead of via the wireless base stations 204, 202, and 206. The secondary route may be used when the primary route is not available. In addition, the secondary routes may be used to send low priority packets. For example, when both a high priority and low priority packets are received at a node simultaneously, the high priority packet, such as a voice packet, may be sent by the primary route and a low priority packet, such as a data packet, may be sent by a secondary route.

In one embodiment, secondary routes may be determined proactively or reactively. In proactive determination of the secondary routes, one or more secondary routes are determined in advance before the primary route is rendered unusable. When the primary route is unusable, an already determined secondary route may be used to send the request. Proactive determination of the secondary routes reduces delays in sending requests. In reactive determination of the secondary route, the secondary route is determined after a primary route becomes unusable. In the reactive determination of secondary routes, the request waits until the determination of the secondary route, and is sent afterwards on determination of the secondary route.

At step 404, on receiving the at least one request for route, the wireless base station generates a batch route request, based on the received requests. Generating the batch route request includes identifying the requests to be batched together, based on predefined parameters. The predefined parameters include the time duration of the association of the one or more source node with the corresponding wireless base station, for example, a node associated with a wireless base station for a longer duration may get preference. The predefined parameters further include a priority of the one or more source nodes, a priority of data (e.g., voice or video) type; for example, video data may get preference over voice data, a number of requests, and a time interval between batch route requests sent by the wireless base station to the network. In an embodiment of the present invention, generating the batch route request includes determining the addresses of at least one destination node in the batch route request. The determined addresses and the address of the wireless base station are utilized to construct the batch route request. In another embodiment of the present invention, generating the batch route request includes entering sequence numbers of the at least one destination node in the batch route request.

At step 406, the batch route request is sent to a network for delivery to the at least one destination node. In an embodiment of the present invention, the batch route request is broadcast to the hierarchical network 200. In another embodiment of the present invention, the broadcast is a multihop broadcast. At step 408, one or more replies are received at the wireless base station, in response to the batch route request sent. In an embodiment of the present invention the replies are received from the network 100. Based on the one or more replies, routes for the one or more destination nodes may be determined in the network. For example, in the network 100, the node 108 sends a request for determining a route to the node 112. Similarly, the node 110 sends a request for determining a route to the node 114. On receiving the requests for determining routes, the wireless base station 102 generates a batch route request, which is broadcast to the network 100. In response to sending the batch route request one or more replies are received at the wireless base station 102. Based on the one or more replies, routes for the one or more destination nodes may be determined in the network 100.

Similarly, in the hierarchical network 200, the node 214 sends a request for determining a route to the node 218. Similarly, the node 216 sends a request for determining a route to the node 220. On receiving the requests for determining the routes, the wireless base station 208 generates a batch route request. In an embodiment of the present invention, the wireless base station 208 generates the batch route request. In another embodiment of the present invention, the batch route request may be generated by any of the wireless base stations providing coverage to the node 214 and the node 216. For example, the batch route request may be generated by any of the wireless base station 208, wireless base station 204, or the wireless base station 202. On generating the batch route request, the wireless base station 208 sends the batch route request to the hierarchical network 200, for delivery to the node 218 and the node 220. One or more replies are received from the hierarchical network 200 at the wireless base station 208, in response to the batch route request sent. Based on the one or more replies, routes for the node 218 and the node 220 are determined in the hierarchical network 200.

FIG. 5 is a block diagram illustrating a header 500 of a batch route request, in accordance with an embodiment of the present invention, where the fields 502-522 may be in any order and not specifically as shown. Further, other embodiments of the batch route request may not include every field shown in FIG. 5. As shown in FIG. 5, the header 500 includes a ‘version number’ field 502 which denotes the version number of a routing protocol used for the messaging in the network (e.g. a version of the AODV protocol as mentioned above).

The header 500 further includes fields 504-522 for ‘type’,’‘flag values’, hop count’, ‘routing metrics’, ‘ID’, ‘destination sequence number’, ‘source sequence number’, ‘option type’, ‘option length’, and one or more addresses. The ‘type’ field 504 denotes the type of message, e.g. batch route request, route request, route reply, route error, authentication, status request, status reply, etc. The ‘hop count’ field 508 denotes a hop count from the destination wireless base station to the source wireless base station. The hop count is incremented by intermediate wireless base stations forwarding a reply message. The ‘routing metrics’field 510 is updated at every hop with characteristics of the hop. The ‘ID’ field 512 indicates an ID that is specific to the type of message that is identified by the type field 504, e.g. batch route request ID, route request ID, a route reply ID, route error ID, authentication ID, status request ID, status reply ID, etc.

The ‘flag values’ field 506 identifies flag values, e.g. ‘B’, ‘P’, ‘S’, ‘J’, ‘R’, ‘G’, ‘D’, and ‘U’. For example, in one embodiment, the flag value ‘B’ denotes that the request is a broadcast as well as that the broadcast is a multihop broadcast. The flag value ‘P’ indicates that the request is a periodic request. When the request is periodic, then the value of ‘P’ may be 1, otherwise, it may be 0. The flag value ‘S’ denotes the state of the source node, where the state includes an infrastructure state and an ad hoc state. The flag value ‘J’ denotes multicasting of the request. The flag value ‘R’ denotes repair and is used to update routing tables with the state that a route is being repaired. The flag value ‘G’ denotes that a gratuitous reply should be unicast to the node specified in the destination address field. The flag value ‘D’ denotes that only a destination can respond to the request. The flag value ‘U’ denotes that the destination sequence number is unknown.

The ‘source sequence number’ field 514 is filled by the sequence number of the wireless base station sourcing the request for which the reply was generated. The ‘destination sequence number’ field 516 is filled by the sequence number of the destination wireless base station with which the destination node is associated. The ‘option type’ and ‘option length’ fields 518, 520 enable the batch route request to include one or more destinations and the destination addresses of the one or more destination nodes. The header 500 further includes an ‘Addresses’ field 522 where the field comprises one or more addresses of the destination nodes, e.g. a MAC address.

As mentioned previously, an embodiment of the present invention has been described with reference to a layer two implementation; however, as is known to one of ordinary skill in the art, an embodiment of the present invention is contemplated to operate at layer three also. For example, in a layer three embodiment, the ‘Addresses’ field may comprise IP addresses.

Therefore, as described above, the present invention provides a method for sending requests, for example a batch route request, in the network. Sending a batch route request reduces high bandwidth overheads of sending separate requests for each node. In addition, sending the batch route request also reduces high bandwidth overheads in determining secondary routes in a hierarchal network. Delays in determining the routes in the network are also reduced. Moreover, the method described in the present invention is also useful in determining routes, in the event of a link failure when a large number of routes are to be determined.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the present invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. A method for sending requests in a network, the network comprising a plurality of wireless base stations and a plurality of nodes, the plurality of nodes comprising at least one source node and at least one destination node, each of the plurality of nodes associated with at least one wireless base station, the method comprising
at a wireless base station:
receiving a request for at least one destination node from a source node, wherein the source node is associated with the wireless base station,
generating a batch route request based on the request; and
sending the batch route request to the network for delivery to the at least one destination node.

2. The method according to claim 1 wherein the batch route request identifies the at least one destination node with an addresses field that identifies all destination nodes of the at least one destination node that the batch route request will be sent to.

3. The method according to claim 1 wherein generating the batch route request comprises identifying requests to be batched together.

4. The method of claim 3 wherein the step of identifying is based on at least one of a) a duration of association of the source node with the wireless base station, b) a priority of the source node, c) a priority of a type of traffic, d) a number of requests, and e) a time interval between batch route requests sent by the wireless base station into the network.

5. The method according to claim 1 further comprising determining at least one route for the at least one destination node in the network.

6. The method according to claim 1 further comprising receiving replies from the network in response to sending the batch route request.

7. The method according to claim 6 further comprising determining one or more secondary routes for the at least one destination node in the network based on the received replies.

8. The method according to claim 1 wherein generating the batch route request comprises:
determining addresses of the at least one destination node in the batch route request; and
utilizing the determined addresses and an address of the wireless base station to construct the batch route request.

9. The method according to claim 1 wherein generating the batch route request comprises entering sequence numbers of all destination nodes of the at least one destination node in the batch route request.

10. The method according to claim 1 wherein sending the batch route request comprises broadcasting the batch route request to the network.

11. The method according to claim 1 wherein the network is a hierarchical network.

12. The method according to claim 1 further comprising determining routes in a network by receiving replies from the network in response to sending the batch route request.

13. The method according to claim 1 wherein at least one of a) the request and b) the batch route request adhere to at least one of a) a layer two protocol and b) a layer three protocol.

14. A method for sending requests in a hierarchical network, the hierarchical network comprising a plurality of wireless base stations and a plurality of nodes, the plurality of wireless base stations arranged in a hierarchy, the plurality of nodes comprising at least one source node and at least one destination node, each of the plurality of nodes associated with at least one wireless base station, the method comprising:
receiving a batch route request at a second wireless base station from a first wireless base station,
wherein the second wireless base station is identified as a secondary route for the first wireless base station, and
wherein the batch route request is sent by the first wireless base station to the second wireless base station in response to receiving a request from a source node for a destination node.

15. The method according to claim 14 further comprising forwarding the batch route request to the destination node.

16. The method according to claim 15 further comprising receiving replies in response to forwarding the batch route request.

17. The method according to claim 16 further comprising determining a secondary route based upon the received replies.

18. The method according to claim 14 wherein the forwarding comprises broadcasting the batch route request to the network.

19. The method according to claim 14 wherein the batch route request identifies at least one of a) a layer two address of the at least one destination node and b) a layer three address of the at least one destination node.

20. The method according to claim 14 wherein the step of receiving adheres to a wireless ad hoc routing protocol taken from the group of Ad hoc On-demand Distant Vector Routing Protocol, Cluster Based Routing Protocol, Dynamic Source Routing Protocol, Dynamic Distance Sequenced Distance Vector Routing Protocol, and Wireless Routing Protocol (WRP).
